(19) United States
(12) Patent Application Publication
(10) Pub. No.: US 2009/0067996 A1
(43) Pub. Date: Mar. 12, 2009

(54) BLADE BEARING RING ASSEMBLY OF A TURBOCHARGER WITH A VARIABLE TURBINE GEOMETRY

(75) Inventors: Timo Tries, Schwieberdingen (DE); Ralf Boening, Reiffelbach (DE); Dirk Frankenstein, Worms (DE)

Correspondence Address: BORGWARNER INC. C/O PATENT CENTRAL LLC, 1401 HOLLYWOOD BOULEVARD, HOLLYWOOD, FL, 33020-5237, US

(73) Assignee: Borg Warner Inc., Auburn Hills, MI (US)

(21) Appl. No.: 12/279,702

(22) PCT Filed: Feb. 14, 2007
(86) PCT No.: PCT/EP2007/001291

§ 371 Date: Aug. 15, 2008

(30) Foreign Application Priority Data
Feb. 16, 2006 (DE) 10 2006 007 319.3

(51) Int. Cl. F04D 29/056; B23P 15/00; F01D 17/16

(52) U.S. Cl. 415/173.1; 29/888.02; 415/159

(57) ABSTRACT

The invention relates to a turbocharger with a variable turbine geometry. Said turbocharger comprises a blade bearing ring assembly (1) with a blade bearing ring (2) and a disc (3), which can be fixed to the blade bearing ring (2) to create a flow channel (4) and also comprises at least one bearing pin (5), one first end (6) of which is connected to the blade bearing ring (2) and the second end (7) of which is connected to the disc (3). Both ends of the bearing pin are butt welded to the blade bearing ring (2) and the disc (3).

The invention relates to a turbocharger with a variable turbine geometry (VTG) according to the preamble of claim 1.

The VTG cartridge of a turbocharger of this type which is known from EP-A-1 236 866 comprises a stator unit having blades and levers and a disk on the turbine housing side. In turbochargers of the generic type, the disk is fastened to a blade bearing ring of a blade bearing ring assembly by means of screws or welding. In order for it to be possible to set a defined width for the flow channel which is formed between the blade bearing ring and the disk and in which the blades of the VTG are situated, spacer sleeves are required which, in the case of a welded connection, can be removed again after welding. However, a distortion of the disk can be produced by the welding as a consequence of a pronounced introduction of heat. A distortion of the disk can lead to jamming of the blades as a result of the local gap reduction which is caused by this between the blades and the disk.

It is therefore an object of the present invention to provide a turbocharger of the type which is specified in the preamble of claim 1, in which turbocharger it is possible to produce a welded connection which connects the disk to the blade bearing ring as far as possible without distortion, with the result that a constantly uniform spacing is produced as in the case of connection by means of screws.

This object is achieved by the features of claim 1.

A blade bearing ring assembly according to the invention is defined in subclaim 2.

A method according to the invention for producing a blade bearing ring assembly for the turbocharger according to the invention is specified in claims 3 to 5.

The carrying pins preferably have a very small diameter of a few millimeters, in order that the reduction in flow cross section caused by them and the associated flow eddies remain at a minimum.

Further details, advantages and features of the present invention result from the following description of exemplary embodiments using the appended drawing, in which:

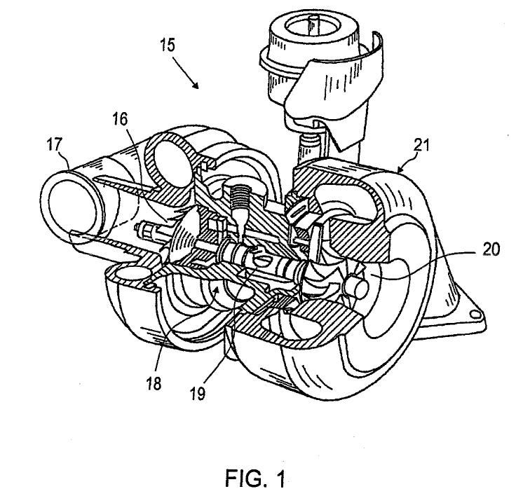

FIG. 1 shows a perspective illustration of a turbocharger according to the invention,

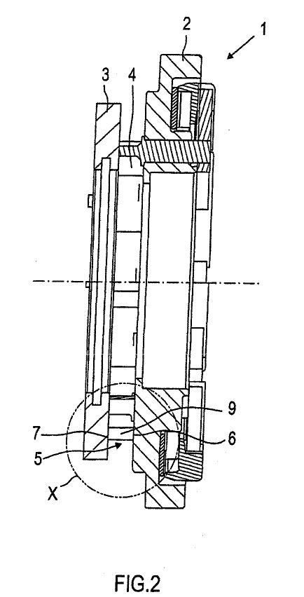

FIG. 2 shows a sectional illustration of a blade bearing assembly for the turbocharger according to the invention, and

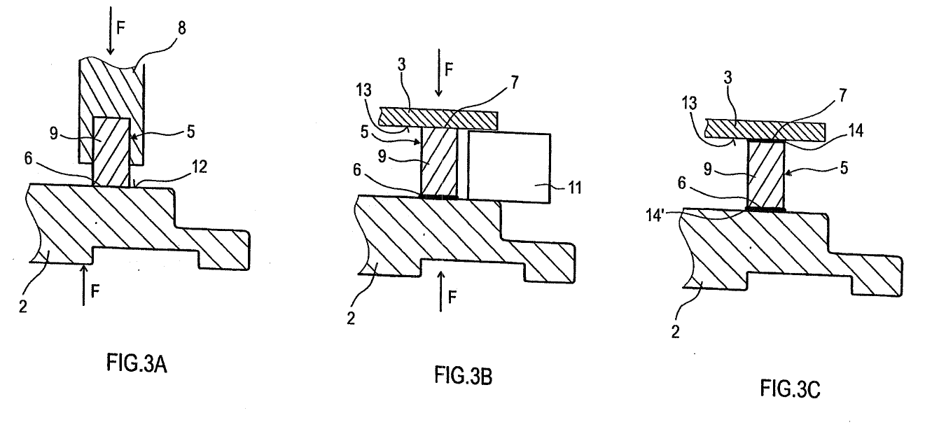

FIGS. 3A-C show the detail X from FIG. 2 in an enlarged illustration in order to explain the method according to the invention.

Since a complete explanation of all the construction details of a turbocharger with a variable turbine geometry is not required for the following description of the construction principles according to the invention, only the principle components of a turbocharger 15 according to the invention are designated in FIG. 1, which turbocharger 15, as is customary, has a compressor impeller 16 in a compressor housing 17, a bearing housing 18 with the required bearings for the shaft 19, and a turbine wheel 20 in a turbine housing 21. The remaining parts are not required for the explanation of the present invention, in order to explain its principles completely, but are of course provided.

Accordingly, FIG. 2 shows only a blade bearing arrangement 1 of a turbocharger according to the invention. The blade bearing assembly 1 has a blade bearing ring 2, on which a disk 3 is arranged at a defined spacing. The disk 3 is preferably configured from the same material as the blade bearing ring 2 and serves, as has been said, to set an exact axial gap, in order for it to be possible to define a flow channel 4.

In order to fasten the disk 3 to the blade bearing ring 2, at least one, but as a rule a plurality of carrying pins are provided, of which one carrying pin 5 can be seen in FIG. 2. The carrying pin 5 has a first and a second end 6 and 7. A shank section 9 which is arranged in the flow channel 4 is arranged between the ends 6 and 7 in the mounted state.

According to the method according to the invention, in order to produce an above-described blade bearing ring assembly 1 according to the invention, the blade bearing ring 2 and the disk 3 are provided in each case with a preferably flat fastening region 12 and 13 for the carrying pin or the carrying pins 5, in addition to the customary production steps for the blade bearing ring 2, the blade shafts, levers and other parts which are usually provided.

Subsequently, in order to fix the disk 3 to the blade bearing ring 2, first of all the first end 6 of the carrying pin 5 is connected in a butted manner to the blade bearing ring 2, that is to say the substantially flat end 6 is placed onto the preferably flat fastening region 12 (FIG. 3A), preferably by way of a positioning tool 8, and is then connected, preferably welded, to the latter (FIG. 3B). The spacing body or the spacing bodies 11 which is/are shown in FIG. 3B are then inserted between the blade bearing ring 2 and the disk 3, in order for it to be possible to set the defined distance between the blade bearing ring 2 and the disk 3. The second substantially flat end 7 of the carrying pin 5 is then connected, preferably welded, to the associated preferably flat fastening region 13 of the disk 3 and the spacing body or the spacing bodies 11 is/are removed. It is possible here according to the invention that first of all either the blade bearing ring or the disk 3 is connected to one of the carrying pin ends and then the other carrying pin end is connected to the respectively other part (that is to say, either to the disk or to the blade bearing ring).

### LIST OF DESIGNATIONS

1 Blade bearing ring assembly
2 Blade bearing ring
3 Disk
4 Flow channel
5 Carrying pin (carrying pins)
6 First end of the carrying pin 5
7 Second end to be welded of the carrying pin 5
8 Positioning tool
9 Shank section
10
11 Spacer piece/body
12 Flat fastening region of 2
13 Flat fastening region of 3
14,14′ Welding zones
15 Turbocharger
16 Compressor impeller
17 Compressor housing
18 Bearing housing
19 Shaft
20 Turbine wheel
21 Turbine housing

1. A turbocharger with a variable turbine geometry
having a blade bearing ring assembly (1) which has a blade bearing ring (2) and a disk (3) which can be fixed on the blade bearing ring (2) in order to produce a flow channel (4);
having at least one carrying pin (5) which is connected by way of a first end (6) to the blade bearing ring (2) and which is connected by way of a second end (7) to the disk (3);
wherein both ends (6, 7) of the carrying pin (5) are welded in a butted manner to the blade bearing ring (2) and the disk (3), respectively.

2. A blade bearing ring assembly (1) for a turbocharger with a variable turbine geometry
having a blade bearing ring (2) and a disk (3) which can be fixed on the blade bearing ring (2) in order to produce a flow channel (4); and
having at least one carrying pin (5) which is connected by way of a first end (6) to the blade bearing ring (2) and which is connected by way of a second end (7) to the disk (3), wherein both ends (6, 7) of the carrying pin (5) are welded in a butted manner to the blade bearing ring (2) and the disk (3), respectively.

3. A method for producing a blade bearing ring assembly (1) for a turbocharger, comprising the following method steps:
fastening of the first end (6) of the carrying pin or carrying pins (5) to a preferably flat fastening region (12) of a blade bearing ring (2) or of a disk by means of a material to material connection;
arranging of spacer bodies (11) between the blade bearing ring (2) and the disk (3);
fastening of the second end (7) of the carrying pin (5) to a likewise preferably flat fastening region (13) of the disk (3) or of the blade bearing ring (2) by means of a material to material connection; and
removal of the spacer bodies (11) after fastening of the ends (6, 7) of the carrying pin (5).

4. The method as claimed in claim 3, wherein a weld (14, 14′) is used as material to material connection.

5. The method as claimed in claim 3, wherein spacer bodies (11) which are not thermally conductive are used.
